(19) United States
(12) Patent Application Publication
(10) Pub. No.: US 2025/0243087 A1
(43) Pub. Date: Jul. 31, 2025

(54) WASTEWATER PURIFICATION SYSTEM

(71) Applicant: Paulee Cleantec Ltd., Tel Aviv (IL)

(72) Inventors: Ilan Levy, Kfar Harif (IL); Oded Halperin, Bazra (IL)

(73) Assignee: Paulee Cleantec Ltd., Tel Aviv (IL)

(21) Appl. No.: 18/854,651

(22) PCT Filed: Apr. 18, 2023
(86) PCT No.: PCT/IB2023/053966

§ 371 Date: Oct. 7, 2024

Related U.S. Application Data
(60) Provisional application No. 63/334,258, filed on Apr. 25, 2022.

(51) Int. Cl. C02F 1/04; C02F 1/72; C02F 101/30; C02F 103/00; C02F 103/20; C05F 7/00

(52) U.S. Cl. CPC C02F 1/043; C02F 1/72; C05F 7/00; C02F 2101/30; C02F 2103/005; C02F 2103/20; C02F 2303/02

(57) ABSTRACT

A method of organic waste treatment includes separating contents of an organic waste stream into separated liquids and separated solids, and causing the liquids to flow to one or more pads. The pads become soaked and concentrated with the liquids. The pads that are concentrated with the liquids are converted into organomineral fertilizer by composting them or by treating them with an oxidant to create sterile odorless ash. Additionally or alternatively, the liquid can evaporate from the pads to leave solids on the pads.

### FIELD OF THE INVENTION

The present invention relates to methods for treating wastewater containing organic waste such as municipal or industrial sewage, biogas digestates, and animal exudates.

### BACKGROUND OF THE INVENTION

There are many methods for treating organic waste. For example, in waste sludge dewatering, waste sludge may be treated to obtain a dry product. The dry product may provide a substantial reduction in storage volume, facilitate transportation, and reduce energy in instances where incineration of the product is performed. Chemical conditioning may be utilized to facilitate dewatering of waste sludge. The conditioning may cause the flocculation of suspended particulates in the waste sludge.

### SUMMARY OF THE INVENTION

The present invention seeks to provide a novel organic waste treatment process, as described in detail below.

There is thus provided in accordance with an embodiment of the present invention a method of organic waste treatment including separating contents of an organic waste stream into separated liquids and separated solids, causing the liquids to flow to one or more pads, the one or more pads becoming soaked and concentrated with the liquids, and converting the one or more pads that are concentrated with the liquids into organomineral fertilizer by composting them or by treating them with an oxidant to create sterile odorless ash. The separated solids may also be treated with oxidant to create a sterile odorless ash.

In an embodiment of the invention, the liquids evaporate from the one or more pads, and as the liquids evaporate, total suspended solids (TSS) and/or total dissolved solids (TDS) become separated from the liquids and remain on the one or more pads, and the method includes treating the one or more pads, which have the TSS and TDS remaining on them, with the oxidant or another oxidant to create more sterile odorless ash.

The liquids may evaporate from the one or more pads by means of natural convection.

The liquids may evaporate from the one or more pads by means of forced convection. The forced convection may include blowing air over the one or more pads and using the air that has passed over the one or more pads as an evaporative cooler. The evaporative cooler may be used to cool livestock areas or cool milking livestock to increase milk production.

The one or more pads may be made of an organic, biodegradable matrix. The one or more pads may be pre-soaked or pre-loaded with mineral fertilizers.

Prior to oxidization of the one or more pads, the one or more pads may be ground and biologically or chemically composted.

The invention has many applications for treating any source of wastewater containing organic waste, such as municipal or industrial sewage and animal exudates. For example, the invention may be used in building and wastewater treatment plants and may provide significant energy savings by doing away with the need for different processes, such as a thickening stage, where polymer and centrifuges are used.

### BRIEF DESCRIPTION OF THE DRAWINGS

The present invention will be understood and appreciated more fully from the following detailed description, taken in conjunction with the drawings in which:

FIG. 1 is a flow chart of an organic waste treatment process in accordance with a non-limiting embodiment of the present invention.

### DETAILED DESCRIPTION OF EMBODIMENTS

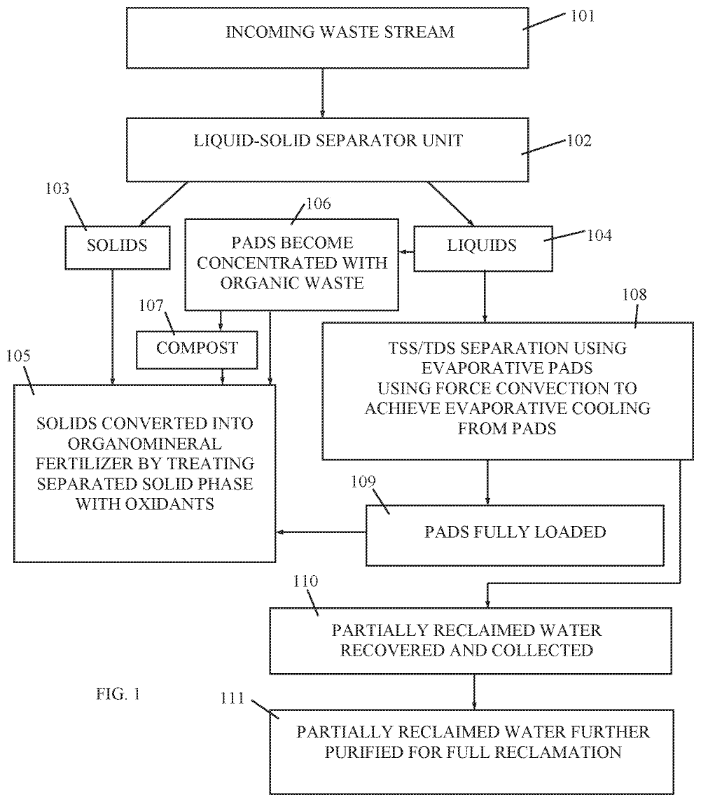

Reference is now made to FIG. 1, which illustrates an organic waste treatment process in accordance with a non-limiting embodiment of the present invention. The process may be carried out in a portable or non-portable system.

In step 101, an incoming waste stream flows or is otherwise transported to the system of the invention. The waste may be, without limitation, from animal processing or animal feeding separation, such as bovine farms, dairy farms, chicken farms, swine farms, equine ranches and others, manure from lagoons, human waste, municipal or industrial wastewater treatment plants, food processing plants, biogas effluents (digestate) and many more. Waste may be transported by regular pipes, pumps or other suitable techniques. Another example is sewage or septic trucks, which in accordance with the invention, can transport collected waste to the system (which may be located in a municipality, for example). The system may include a buffer tank for temporarily storing waste from more than one such truck before the waste goes to a settling tank in the process described below.

In step 102, the incoming waste stream is fed to a dewatering liquid-solid separator unit. There are many dewatering liquid-solid separator units, commercially available from many companies and well known in the art, such as such as screen filters, screw press filters and many more.

As is known, sludge dewatering is the separation of a liquid and solid phase whereby, generally, the least possible residual moisture is required in the solid phase and the lowest possible solid particle residues are required in the separated liquid phase (in centrifugal units, this is called the centrate).

Before doing liquid/solid physical separation, the waste stream may optionally flow to a mixing and settling tank, where it is mixed with flocculation agents, such as but not limited to, polymer (e.g., polyelectrolyte, cationic or anionic). The solid waste particles, such as colloids, are dispersed or suspended in the waste stream, and due to flocculation they form larger-size clusters or flocs which settle at the bottom of the tank as sedimentation. Alternatively, the waste particles in the stream may simply settle by gravity in the settling tank without the help of flocculation agents.

Accordingly, the dewatering liquid-solid separator unit of step 102 separates the wastes into solids 103 and liquids 104.

In step 105, the solids may be converted into organomineral fertilizer, by treating the separated solid phase with oxidants, such as in accordance with the system and method of U.S. Pat. No. 9,936,842. Solid phase oxidizing treatment can take place at the same location where the separation took place or in a different geographic location. In such a system, the separated solid phase of the organic waste is treated by an oxidizing agent to reduce its water content which may involve an exothermic reaction, thereby to reduce bad odor, microbial contamination, parasites and infectious disease.

The oxidizing agent may be, without limitation, potassium permanganate or any other oxidizing agent, and it is mixed with the organic waste in a reactor to initiate an oxidizing reaction in which the water content is lowered and the organic matter is oxidized. What remains is sterile odorless ash with significant lower water content. This ash can be used as a fertilizer or as a source of minerals for the chemical industry. Alternatively, the solids may be biologically composted by other methods known in the art.

In step 106, the liquids flow to one or more pads, which have a large area (scc below) for receiving waste liquids and solids. (Prior to this, the liquid may be directed to a sedimentation tank for particle settlement.) The flow may be by means of dripping, spraying, stream flow, uniform or non-uniform flow, etc. In one embodiment of the invention, the pads become soaked and concentrated with the liquid waste water. The waste-concentrated pads may then be composted (step 107) or may be converted into organomineral fertilizer by treating with oxidants, as in step 105.

The pads can be organized along walls or packed in closed chambers such as in a container. The liquid fraction can be chemically treated, such as for adjusting the pH, prior to its application on the pads. The liquid fraction can be biologically treated such as for ammonia strapping, prior to its application on the pads

Additionally or alternatively, in step 108, the liquid waste water may evaporate from the pads, either by natural convection or forced convection using a blower or other air mover. As the liquid waste water evaporates, total suspended solids (TSS) and/or total dissolved solids (TDS) become separated from the evaporated liquid and remain on the pads.

If forced convection is used, the evaporative pads may be synergistically used as evaporative coolers, such as to cool livestock areas, such as dairy cows, whose milk production increases by cooling the temperature of their environment.

The TSS/TDS separation using evaporative pads may be carried out, without limitation, as in aerobic waste water trickle-bed reactors.

In any of the embodiments of the invention, the evaporative pads may be made of an organic, biodegradable matrix like cardboard or any other organic matrixes, for example, straw, cotton branches or biochar. They may have a large surface area, e.g., larger than 300 m²/m³. Prior to their use, they may be pre-soaked or pre-loaded with mineral fertilizers to enrich their plant nutritional value at their final use. The pads do not need any biocide soaked on their surface area. They do not need any plastic, tar or asphalt coating.

In step 109, after the pads have become fully loaded with organic mass, the pads may be sent to the oxidizing unit of step 105, in which the solids-saturated pads may be converted into organomineral fertilizer. Before the oxidization process, the pads may be removed, ground and biologically or chemically composted, thereby reclaiming all the organics and enriched minerals in the organomineral fertilizer. Afterwards, the spent pads are replaced with fresh pads and the process repeated. The concentrated wastewater can be later on used as liquid fertilizer.

In step 110, partially reclaimed water may be recovered and collected from the TSS/TDS separation step. In step 111, the partially reclaimed water may be further purified for full reclamation. Without limitation, this may be done by effluent treatment with any known effluent treatment process in order to bring the reclaimed water to a desired quality according to regulations and needs.

What is claimed is:

1. A method of wastewater treatment comprising:
separating contents of an organic waste stream into separated liquids and separated solids;
causing said liquids to flow to one or more pads, said one or more pads becoming soaked and concentrated with said liquids; and
converting said one or more pads that are concentrated with said liquids into organomineral fertilizer by composting them or by treating them with an oxidant to create sterile odorless ash.

2. The method according to claim 1, wherein said liquids evaporate from said one or more pads, and as said liquids evaporate, total suspended solids (TSS) and/or total dissolved solids (TDS) become separated from said liquids and remain on said one or more pads; and treating said one or more pads, which have said TSS and TDS remaining on them, with said oxidant or another oxidant to create more sterile odorless ash.

3. The method according to claim 1, further comprising treating said separated solids with said oxidant or another oxidant to create a sterile odorless ash.

4. The method according to claim 1, wherein said one or more pads are made of an organic, biodegradable matrix.

5. The method according to claim 1, wherein said one or more pads are pre-soaked or pre-loaded with mineral fertilizers.

6. The method according to claim 1, wherein prior to oxidization of said one or more pads, said one or more pads are ground and biologically or chemically composted.

7. The method according to claim 2, wherein said liquids evaporate from said one or more pads by means of natural convection.

8. The method according to claim 2, wherein said liquids evaporate from said one or more pads by means of forced convection.

9. The method according to claim 7, wherein said forced convection comprises blowing air over said one or more pads and using said air that has passed over said one or more pads as an evaporative cooler.

10. The method according to claim 8, comprising using said evaporative cooler to cool livestock areas.

11. The method according to claim 8, comprising using said evaporative cooler to cool milking livestock to increase milk production.

12. The method according to claim 1, wherein said organic waste stream is derived from animal processing or animal feeding.

13. The method according to claim 1, wherein said organic waste stream is derived from human waste, municipal or industrial wastewater treatment.

14. The method according to claim 1, wherein said organic waste stream is derived from biogas effluents or digestate.

15. The method according to claim 1, wherein said one or more pads are organized along walls or packed in a closed chamber.

16. The method according to claim 1, wherein said liquids are chemically treated prior to application on said one or more pads.

17. The method according to claim 1, wherein said liquids are biologically treated prior to application on said one or more pads.
